(19) United States
(12) Patent Application Publication
(10) Pub. No.: US 2026/0289624 A1
(43) Pub. Date: Sep. 24, 2026

(54) System and Method for Automatically Identifying and Managing Stock of Products From Non-Standardized Packaging

(71) Applicant: Chewy, Inc., Plantation, FL (US)

(72) Inventors: Randal Erman, San Marcos, CA (US); David Goverman, Seattle, WA (US); Jared Molton, Seattle, WA (US)

(73) Assignee: Chewy, Inc., Plantation, FL (US)

(21) Appl. No.: 19/475,155

(22) PCT Filed: Apr. 24, 2024
(86) PCT No.: PCT/US2024/025966

§ 371 Date: Oct. 14, 2025

Related U.S. Application Data
(60) Provisional application No. 63/497,901, filed on Apr. 24, 2023.

(51) Int. Cl. G06Q 30/0601; G06Q 10/087; G06V 10/74; G06V 30/146

(52) U.S. Cl. CPC G06Q 30/0623; G06Q 10/08726; G06Q 30/0631; G06V 10/761; G06V 30/147

(57) ABSTRACT

A method of identifying a product from a digital image includes receiving, at a digital identification service, image data associated with a digital image of an unregistered packaged product, and programmatically processing the image data, via the digital identification service, to identify a registered product that is different from and similar to the unregistered packaged product.

### CROSS-REFERENCE TO RELATED APPLICATIONS

This application claims the benefit of U.S. Provisional Patent Application No. 63/497,901 filed Apr. 24, 2023 entitled “System and Method for Automatically Identifying and Managing Stock of Products From Non-Standardized Packaging”, which is incorporated by reference herein in its entirety.

### TECHNICAL FIELD

The present disclosure generally relates to systems and methods for identifying a product based on an image thereof and more specifically, to systems and methods for automatically identifying a product based on an image and automatically managing stock of that product or an equivalent thereof.

### SUMMARY

In one embodiment there is method of identifying a product from a digital image, the method includes receiving, at a digital identification service, image data associated with a digital image of an unregistered packaged product, and programmatically processing the image data, via the digital identification service, to identify a registered product that is different from and similar to the unregistered packaged product.

In some embodiments the method further includes rendering on a digital user interface, via a gateway coupled to the digital identification service, at least one of: i) a selectable offer to purchase the identified registered product; and ii) registered product information corresponding to the identified registered product. In some embodiments the method further includes identifying a registered user associated with the digital image and wherein the registered product information includes recommendations based on registered user pet information. In some embodiments, the programmatically processing includes processing the digital image with an image refinement engine to produce a refined digital image, processing the refined digital image with an optical character recognition utility to identify blocks of data on the refined digital image, and applying a confidence scoring engine to the identified blocks of data to map information contained within the blocks of data to an existing label information hierarchy.

In some embodiments, the programmatically processing includes generating a final data model associated with the digital image that includes a determined confidence score based on a programmatic weighting and decoding metrics, image quality and similarity attributes. In some embodiments the method further includes rendering on a user device running client software associated with the digital identification service and configured to capture the digital image, at least one of i) alignment bars, ii) lighting sufficiency indication, iii) a text overlay, iv) a menu, v) rotation functionality, and vi) panoramic image flattening functionality. In some embodiments, the digital file includes a set of edge calculated and decoded information related to the digital image that is configured to aid in the programmatically processing step.

In some embodiments the method further includes establishing an order for recurring shipment of the registered product based on receiving, via the gateway coupled to the digital identification service, a selected offer from a digital user interface. In some embodiments the method further includes at the gateway, programmatically determining a product replenishment date based on the number of units of product included in the unregistered product, and an expected or intended usage interval of the units of the product, and at a point in time at or prior to the product replenishment date, rendering on a digital user interface a replenishment notification including an offer for sale of the identified registered product.

In some embodiments, the unregistered packaged product is a prescription medication including identifying indicia printed thereon, the identifying indicia including one or more of an indication of product name, quantity, expiration date, dosage, a prescribed subject, and a prescribing entity. In some embodiments, the unregistered packaged product is packaged in a dram. In some embodiments, receiving image data associated with a digital image of an unregistered product includes receiving image data associated with a plurality of digital images of the unregistered product.

In another embodiment there is a system for identifying a product from a digital image, the system includes a digital identification service configured to receive image data associated with a digital image of an unregistered packaged product, and programmatically process the image data to identify a registered product that is different from and similar to the unregistered packaged product.

In some embodiments, the digital identification service is further configured to render on a digital user interface at least one of: i) a selectable offer to purchase the identified registered product; and ii) registered product information corresponding to the identified registered product. In some embodiments, the digital identification service is further configured to identify a registered user associated with the digital image and wherein the registered product information includes information about the use of the registered product in connection with a pet associated with the registered user. In some embodiments, the digital identification service is further configured to process the digital image with an image refinement engine to produce a refined digital image, process the refined digital image with an optical character recognition utility to identify blocks of data on the refined digital image, and apply a confidence scoring engine to the identified blocks of data to map information contained within the blocks of data to an existing label information hierarchy.

In some embodiments, the digital identification service is further configured to generate a final data model associated with the digital image that includes a determined confidence score based on a programmatic weighting and decoding metrics, image quality and similarity attributes. In some embodiments the system further includes a gateway in communication with the digital identification service and configured to programmatically determine a product replenishment date based on the number of units of product included in the unregistered product, and an expected or intended usage interval of the units of the product, and at a point in time at or prior to the product replenishment date, render on a digital user interface a replenishment notification including an offer for sale of the identified registered product.

### BRIEF DESCRIPTION OF THE DRAWINGS

The following detailed description of embodiments of the system and method, will be better understood when read in conjunction with the appended drawings of exemplary embodiments. It should be understood, however, that the invention is not limited to the precise arrangements and instrumentalities shown.

In the drawings:

FIG. 1 is a block diagram illustrating an implementation of a system for automatically identifying and maintaining inventory of one or more products in accordance with an exemplary embodiment of the present disclosure;

FIGS. 2A-2F are exemplary user interfaces for automatically identifying and maintaining inventory of one or more products in accordance with an exemplary embodiment of the present disclosure; and

FIG. 3 illustrates an exemplary flow chart for a method of automatically identifying a product and managing an inventory record of the product, in accordance with an exemplary embodiment of the present disclosure.

### DETAILED DESCRIPTION

Products (e.g., pet medications) having expected and/or suggested usage intervals are typically sold as a unit consisting of a predetermined quantity. In some instances, the quantity of the product sold as a unit is less than the quantity required to adhere to the usage interval thereby resulting in a consumer (e.g., pet owner) purchasing multiple units of the product over a period of time. In instances where the product is a prescription medication, the medication may be provided at a prescribed quantity for use at a prescribed usage interval. For example, flea and tick medications are often sold in one dose packages for administration (e.g., monthly, daily). In instances where the prescription medication is sold by a prescribing entity or party (e.g., a veterinarian) the prescription is often provided in a package, that may be non-standardized. The package may have sparce indicia printed thereon relating to the prescription information and/or product information. The indicia may be organized or applied to the package in configurations that vary from package to package. Customer's wishing to adhere to the prescribed usage interval may need to remember how much of the medication they currently have, when it was administered to, for example, their pet, and/or the prescribed usage interval. Furthermore, it may be difficult for the customer to accurately identify the correct prescription product when attempting to acquire the product from a different party other than the initial source. This problem may be multiplied where multiple medications and/or multiple pets are being cared for. Lapses in the customer's ability to adhere to the prescribed usage interval for such medications can lead to negative health effects experienced by their pets that can be expensive and time consuming.

Customers may also have an interest in acquiring information about a product (e.g., medication) that may not be included in the indicia appearing thereon. For example, the indicia may include a listing of ingredients and a customer may be interested in learning more detailed information about the individual ingredients, which is not included in the indicia.

Numerous details are described herein in order to provide a thorough understanding of the example embodiments illustrated in the accompanying drawings. However, some embodiments may be practiced without any of the specific details, and the scope of the claims is only limited by those features and aspects specifically recited in the claims. Furthermore, well-known methods, components, and circuits have not be described in exhaustive detail so as not to unnecessarily obscure pertinent aspects of the embodiments described herein.

Some embodiments of the present disclosure describe systems and methods for identifying information of unregistered products that are unknown or unidentified in a database included in the system described herein. Such unregistered products may be associated with registered products in some embodiments of the present disclose. Embodiments of the present disclosure, for example, allow for the identification of unregistered packaged product information and/or the collection or creation of additional information about those products and/or similar products.

In one embodiment, a system and method of the present disclosure may be used to associate an unregistered packaged product sold by a first party with a registered product sold by a second party that is different from or unaffiliated with the first party. In some embodiments, the unregistered packaged product may include a finite amount of a product that has an intended or expected usage interval (e.g., a prescribed dose of a pet medication). For an end consumer to properly adhere to a prescribed usage interval the end consumer is often required to determine a substantial equivalent product and timely acquire that equivalent. However, this process is often time consuming and prone to lapses in the consumers memory. As such, some embodiments of the present disclosure provide for the automatic determination of a matching registered product as well as the automatic generation of reminders based on an image of the unregistered packaged product, thereby reducing the mental burden and time required by the end consumer.

Aspects of the present disclosure are discussed with reference to unregistered packaged products. The unregistered packaged products may include one or more units of a specific product enclosed within a package having a known or unknown form factor when compared to a best matching registered product. For example, a registered product that is a substantial match or a suitable equivalent for a specific unregistered packaged product may be enclosed within a package or container that is different in at least one aspect than that of the unregistered packaged product. Unregistered packaged products may be enclosed within packages that vary, between package to package, in size, form factor, shape, material and/or appearance. In some embodiments, the appearance of unregistered packages vary in at least one of color, size, shape, and/or material and the system of the present disclosure may be configured to determine a substantially matching registered product. Unregistered packaged products may include variability in identifying indicia (e.g., text) included therewith or printed thereon. An unregistered product, or alternatively an unregistered packaged product, may include a package used for containing a product (e.g., a canine heartworm medication) that includes text that is, in at least one manner, not represented in a database of the system of the present disclosure. The text appearing on the package of the unregistered product may include different content than, be arranged differently than, and/or be inconsistent with registered product data stored in the database. For example, an unregistered product may be a dram for containing a canine heartworm medication that includes a label. The label may have text printed thereon that indicates the name of the prescribing veterinarian, the name of the pet prescribed the medication, the number of medication tablets included therein, the date the medication was prescribed, an expiration date, a generic name of the medication, and/or an advised administration interval (e.g., one tablet per month). However, the text of the label may in some manner be different from the registered product data stored in the database.

The systems and methods discussed herein may be applied to a wide variety of unregistered packaged products including any shape and/or size package. Some examples of non-standardized package types may be, but are not limited to, vials, drams, woven or composite bags (e.g., polypropylene bags), boxes, blister packs, bottles, and jars, where any one of the package types may include a wide range of package dimensions and/or form factors. Non-standardized packages may further refer to variability in identifying indicia between different unregistered packaged products. Identifying indicia may be printed on labels that are applied to said packages. In some instances, non-standardized aspects of the unregistered packages may include variability in label placement, orientation on a package, languages the indicia is printed in, and/or what types of identifying indicia are included. For example, types of identifying indicia for a first unregistered packaged product could include an indication of only a generic product name and dosage amount whereas types of identifying indicia for a second unregistered packaged product may include an indication of a prescribing entity, a retail name of the product, expiration date of the product, intended usage interval of the product, and a subject being prescribed the product.

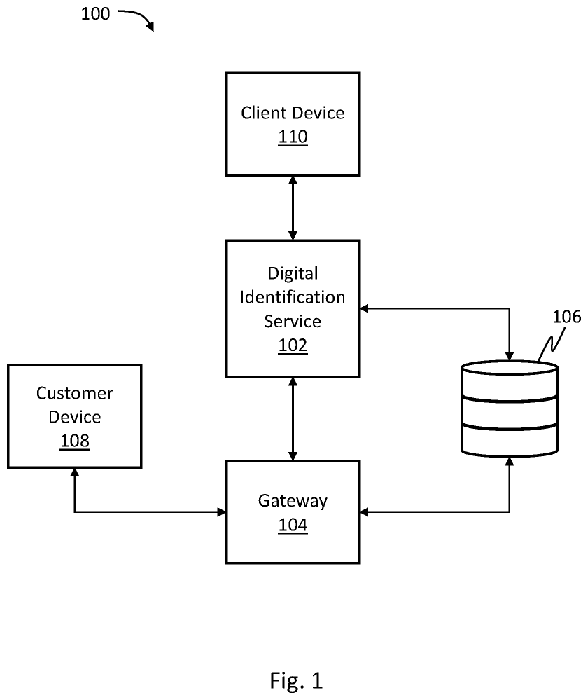

Referring to the drawings in detail, wherein like reference numerals indicate like elements throughout, there is shown in FIG. 1 a system 100 for identifying information of an unregistered packaged product and based on the identified information, determining a registered product that is a match (e.g., a direct match, substantial equivalent, or a reasonable substitute thereof) to the unregistered product, in accordance with an exemplary embodiment of the present disclosure. In some embodiments, the system 100 is configured to accurately identify information about of a product based on visual aspects of the product, its packaging and/or indicia applied thereto. In some embodiments, system 100 identifies information about the product without human intervention in the identification (e.g., without clues, partial identifications or human prompts). In some embodiments, the system 100 is configured to automatically generate additional information about the product. In some embodiments, the system 100 is configured to generate additional information including, but not limited to, a reminder related to a usage interval, expected refill status, or effectiveness of the product in a manner that does not require user memory or physical data entry.

In one embodiment, the system 100 includes one or more computers or computing devices having one or more processors and memory (e.g., one or more nonvolatile storage devices). In some embodiments, memory or computer readable storage medium(s) of memory store programs, modules and data structures, or a subset thereof, for a processor to control and run the various systems and methods disclosed herein. In one embodiment, a non-transitory computer readable storage medium having stored thereon computer-executable instructions which, when executed by a processor, performs one or more of any combination of the methods or steps disclosed herein.

There is shown in FIG. 1 a block diagram illustrating an implementation of the system 100. While some example features are illustrated, various other features have not been illustrated for the sake of brevity and so as not to obscure pertinent aspects of the example embodiments disclosed herein. The system 100 may include a digital identification service 102 that may include or rely upon one or more servers or serverless environments such as, but not limited to, a software Lambda.

The system 100 may include a gateway 104 comprising one or more public or private microservice application program interfaces. In some embodiments, the system 100 includes a database 106, a customer device 108 and a client device 110. The digital identification service 102 may be in communication with at least one of the gateway 104, client device 110, and database 106. In some embodiments, the digital identification service 102 is in communication with the customer device 108. In some embodiments, the client device 110 is in communication with the gateway 104. In some embodiments, one or more of the digital identification service 102 and/or gateway 104 includes a collection of networked computing devices, servers and/or processing units in communication with one another. For example, the digital identification service 102 may include a plurality of different networked computing devices in communication with one another via a network such as the Internet. The digital identification service 102 and/or gateway 104 may be scalable in at least one manner (e.g., horizontally scalable, vertically scalable) to accommodate for increases in processing requests received at the digital identification service 102 and/or gateway 104 (e.g., increases in a number of devices and/or requests to access functionalities of the gateway 104 and/or digital identification service 102).

The digital identification service 102 may be configured to receive at least one image of an unregistered packaged product, or portions thereof, and accurately determine and/or identify information related to the unregistered packaged product. The determined information may include: the identity of the unregistered packaged product, information related to usage of the unregistered packaged product, and/or the identity of the seller of the unregistered packaged product. In some embodiments, the digital identification service 102 is configured to determine data for a matching registered product based on the determined information of the unregistered packaged product. The determined data for the matching registered product may include: other sellers of the unregistered packaged product (or products that are substantially identical or similar to the registered packaged product), alternative formats of the unregistered packaged product, alternative products having benefits to a user (or a user's pet) that are similar to the unregistered packaged product; information related to the effectiveness of the matching registered product, customer reviews of the matching registered product, information related to any recalls of the matching registered product, information related to an expiration date and/or shelf life of the matching registered product, and/or information about a unique identifier (e.g., a stock keeping unit (SKU)), among other things.

In aspects of the system and method, the information related to the unregistered packaged product is obtained despite the packaged product being in a non-standardized format and having indicia on the packaging that is not standardized (e.g., not in a standardized order, standardized geometry, standardized dimensions and/or standardized configuration). In some aspects, information on the unregistered package may have text that conveys information in a different way than is previously known by the system 100. For example, dosage information may be provided in different units (e.g., 1 dose v. 1 pill) or described in a different way (e.g., 1 pill daily v. 25 mg daily). In some instances, dosage information printed on the unregistered package may be in different units, languages and/or the content of the usage instructions may vary between packages (e.g., instructions to take with first bite of food v. instructions to take in morning). In some aspects, symbols or abbreviations may be different from product to product.

In some instances, the unregistered packaged product may be sold by an entity that is different from or unaffiliated with the entity that owns or controls the system 100 described herein (e.g., a third-party entity that is not the entity providing the gateway 104). For example, the unregistered packaged product may be a packaged prescription product sold by unaffiliated entities. In some instances, the unregistered packaged product is sold by, for example, a veterinarian, veterinarian clinic, third-party retailer, online retailer, and/or product vendor. The digital identification service 102 may be configured to determine the identity of alternative product sellers based on a match of a packaged product identified from the received image thereof. The parties, as referenced herein, may refer to any entity offering a product for sale, which may include, but is not limited to: online retailers, brick-and-mortar stores, veterinarians, veterinary clinics, and wholesale retailers.

The second party that provides, hosts, and/or is in control of the gateway 104 may offer for sale, a plurality of different products at a UI generated by the gateway 104. The gateway 104, in some embodiments, is configured to execute one or more different collections of executable code, referred to as microservices, in accordance with a microservice architecture. A microservice as referenced herein may refer to a collection of computer executable code configured to perform a predetermined function. Some example microservices of the gateway 104 may include, but are not limited to, authenticating login credentials, processing order requests, and/or rendering a customer facing storefront UI at a client device 108. One or more of the microservices of the gateway 104 may be accessible by, for example, the digital identification service 102, database 106, a plurality of customer devices 108, and/or client device(s) 110 via an application programming interface (API). The gateway 104 may be configured to provide one or more of the microservices included therewith via a corresponding public microservice API (PMA) layer. For example, one or more PMA layers may be accessible to a plurality of customer devices 108 (e.g., a one-to-many relationship) and one or more PMA layers may be accessible to the digital identification service 102 (e.g., a one-to-one relationship). For sake of brevity though, the functions of the gateway 104 as discussed herein will be described in relation to the gateway 104 and not any individual microservices included therewith that may be configured to perform those functions.

In some embodiments, the gateway 104 may be configured to generate a customer facing UI such that it is accessible via the internet and viewable by a customer on a respective customer device 108. The customer facing UI may be configured to allow one or more customers to view and select registered products for purchase therefrom and/or upload images of unregistered products for comparison and matching by the digital identification service 102. In some embodiments, the system 100 of the present disclosure is configured to receive one or more images of an unregistered product and programmatically determine a similar registered product available for purchase from the customer facing UI. Programmatically, as referenced herein, may include automatically processing (e.g., at the gateway 104 and/or digital identification service 102) computer executable code configured to perform a functionality of the system 100 as discussed herein.

Registered products, as referenced herein may include products having associated data stored on database 106. Registered products may be available for purchase via the customer facing UI. Registered products may be provided within packages having identifying indicia (e.g., text) printed thereon. For example, a registered product may be heartworm tablets for dogs that is provided within a package having text relating to the name of the product, dosage amount, quantity of tablets included therein and a stock keeping unit specific to the entity offering registered products for sale at the customer facing UI. The database 106 may not include registered product data for a registered product that exactly matches the data printed on the label of the unregistered product. For example, the database 106 may include registered product data for registered products that are similar to the unregistered product, however the registered product data may not include data relating to the name of the prescribing veterinarian, the prescribed pet, and a prescribed date. Additionally, the registered product data for a similar registered product may include a different quantity of medication tablets, a different expiration date, and/or a different dosage amount. Furthermore, registered product(s) that is/are similar to the unregistered product may be packaged in a differently sized or shaped package that may, in some instances, include different text or indicia printed thereon that may be arranged differently on the package. For example, the unregistered product may be a dram of a medication and a similar registered product may be provided in a rectangular shaped box and each of which may include text arranged in different ways.

In some aspects of the present disclosure, the system 100 may be configured to receive one or more images of an unregistered product and programmatically determine a matching or similar registered product. In some embodiments, the registered products offered for sale at the customer facing UI are accessible at one or more client devices 108 via a cloud application service. In some embodiments, one or more aspects of the system 100 may be available to external entities such that images of unregistered products may be processed by the system 100 to programmatically determine a matching registered product offered for sale by the external entity. External entities may include entities or parties different than or unaffiliated with the party that owns and/or manages the system 100, such as, but not limited to, businesses, individuals, and/or corporations. In some instances, one or more functionalities of the digital identification service 102 as discussed herein may be available via the Internet to external entities. For example, the digital identification service 102 may be accessible via a systems as a service (SaaS) model to external entities.

The registered products for purchase at the customer facing UI may have associated data stored in the database 106, which may be in communication with the gateway 104 and/or digital identification service 102. There may be a plurality of registered products having associated registered product data stored in the database 106. The registered product data for a registered product may include one or more of product name, unique product identifier (e.g., a stock keeping unit (SKU)), quantity per package, prescription requirements, species for intended use (e.g., cats, dogs, house pets, horses, livestock), and the like. In instances where the registered product data includes an identification of a species for intended use, the registered product data may include an identification as to subspecies, species attributes and/or known indications that the corresponding registered product is intended to address. For example, in an instance where the registered product data corresponds to a canine heartworm medication, the registered product data may include an indication of the canine breeds to which the medication is suitable, a recommended weight range of the canine within which the medication is intended to be used, and/or that the medication is intended to treat heartworms.

In instances where the registered product data stored on database 106 is specific to a prescription medication the registered product data may further include one or more of dosage, suggested usage interval (e.g., one tablet per month, one dose per week), suggested subject weight range, expiration date, ingredients included therein, and number of doses per package. The digital identification service 102 may be configured to leverage the registered product data stored on database 106 when determining a registered product offered for sale by the second party that matches the unregistered packaged product sold by the first party.

In some embodiments, the digital identification service 102 may be configured to associate an unregistered packaged product sold by the second party that matches the registered packaged product with a customer account associated with the gateway 104. A customer account may refer to a digital identity created by or for a customer in a computer or computing system (e.g., gateway 104). A user may access the customer facing UI by interacting with the customer device 108 and inputting login credentials associated with their customer account. The gateway 104 may be configured to detect the login of a customer account and automatically associate inputs at the customer facing UI with that customer account. The database 106 may store customer account specific data including, but not limited to, an indication of: the customer's name, shipping address, payment sources, past interactions with the customer facing UI, and/or purchase history. In some embodiments, the customer account specific data includes pet specific data corresponding to one or more pets owned by the customer. In such instances, the pet specific data for a specific pet may include, but is not limited to, an indication of: the pet's name, age, breed, weight, medical history, prescription medications, preferred veterinarians and/or preferred veterinary clinics. The digital identification service 102 may be configured to automatically associate a received image of an unregistered packaged product with a specific customer account.

The customer device 108 may be configured to enable a customer to generate one or more digital images of an unregistered packaged product and transmit those digital images to the digital identification service 102. The customer device 108 may be operated on any suitable computer device, such as, but not limited to, a mobile phone, a smart phone, a computer, a laptop computer, a tablet device, a netbook, or a personal digital assistant. In some embodiments, the customer device 108 may include an image capture device (e.g., a camera) for generating a digital image of an unregistered packaged product. The digital image may be a color image including a visual indication of one or more colors visible at a surface of the unregistered packaged product. In some embodiments, the customer device 108 may be in communication with the gateway 104 such that an image of the unregistered packaged product may be transmitted to the gateway 104 and the gateway 104 may be configured to transmit the received image to the digital identification service 102 for identification. In other embodiments, the functionalities of the gateway 104 and digital identification service 102 may be combined such that they are performed by a single server. In some embodiments, the digital identification service 102 may be in communication with the customer device 108 such that an image of an unregistered packaged product may be transmitted directly from the customer device 108 to the digital identification service 102.

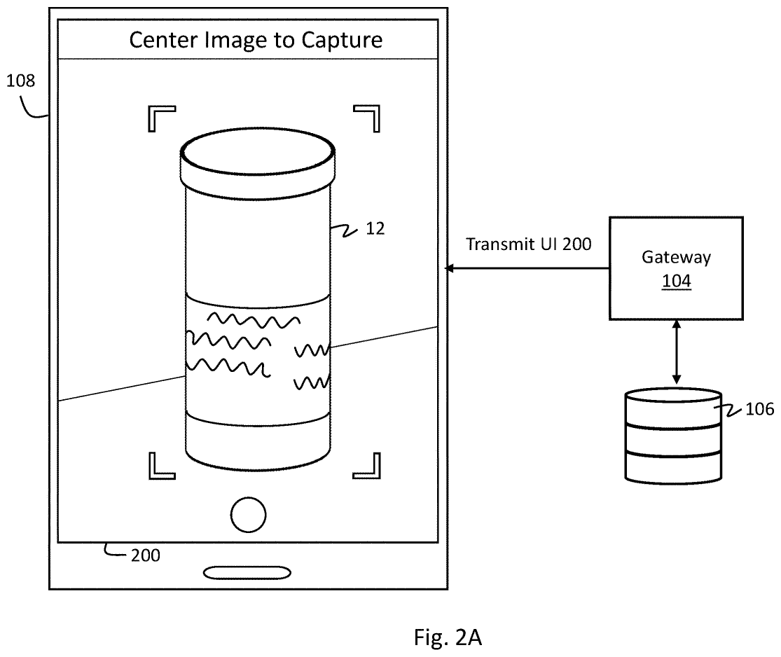

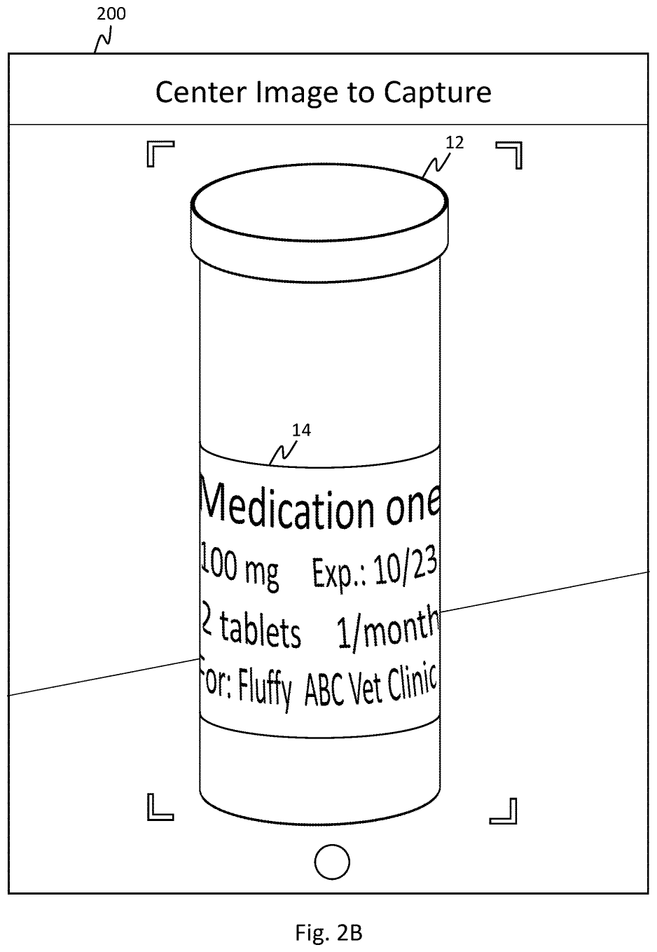

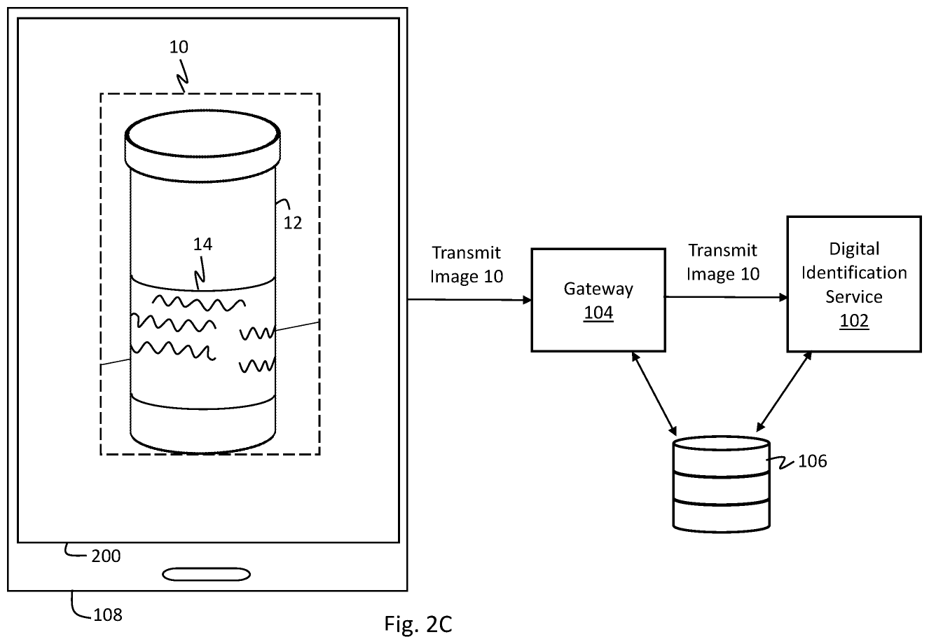

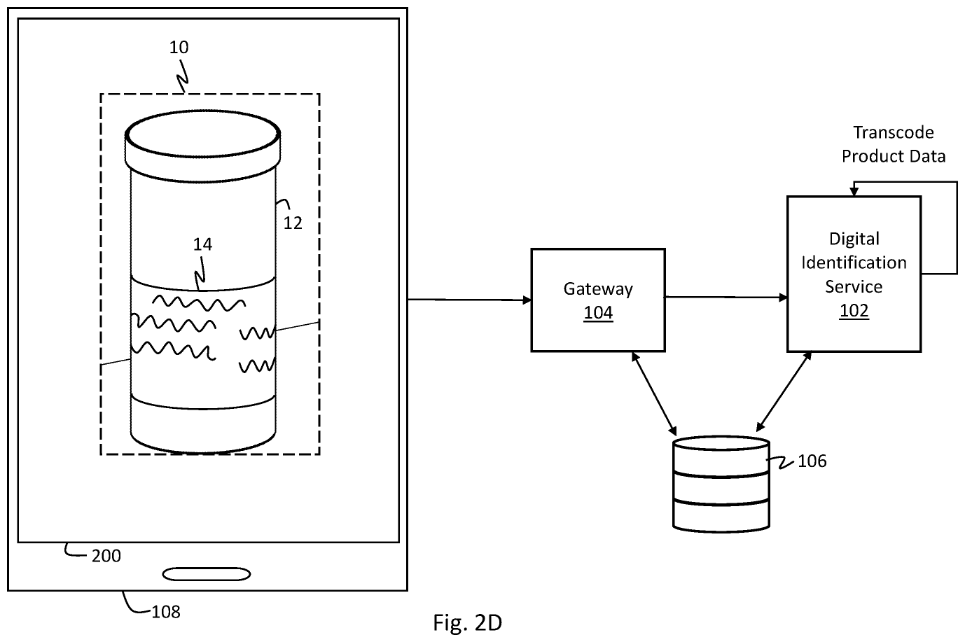

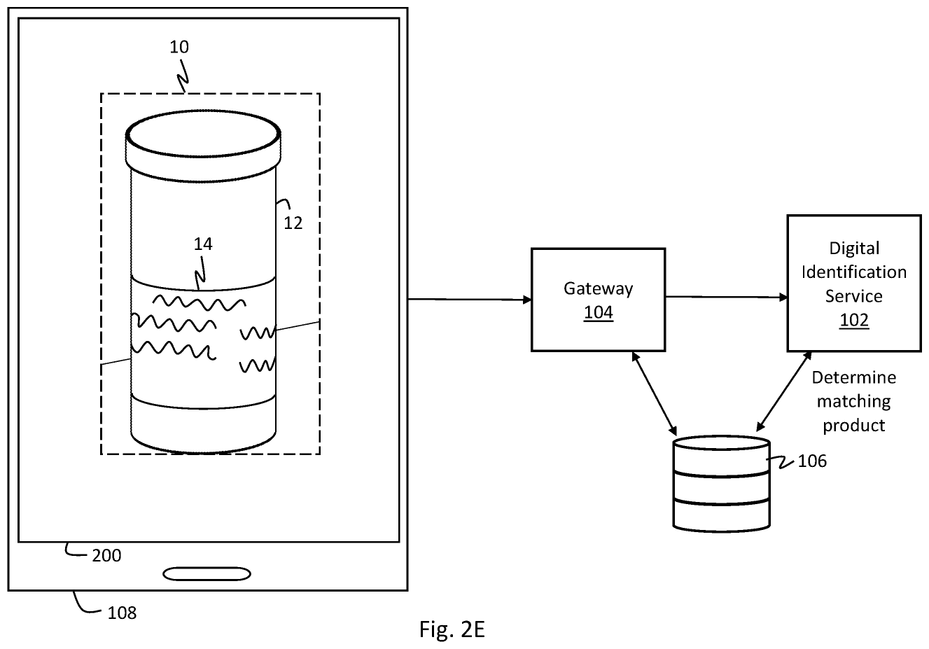

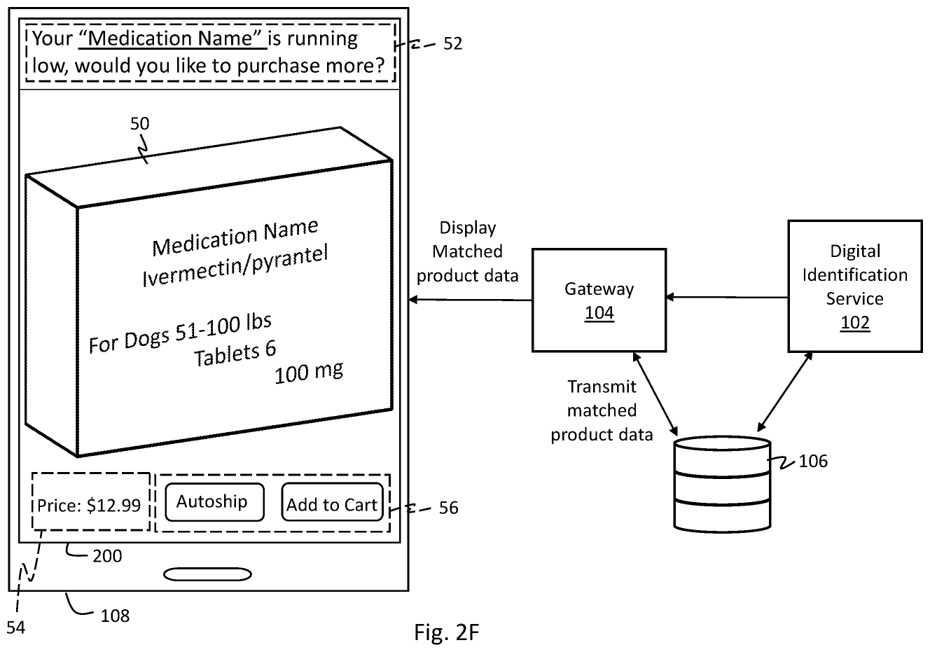

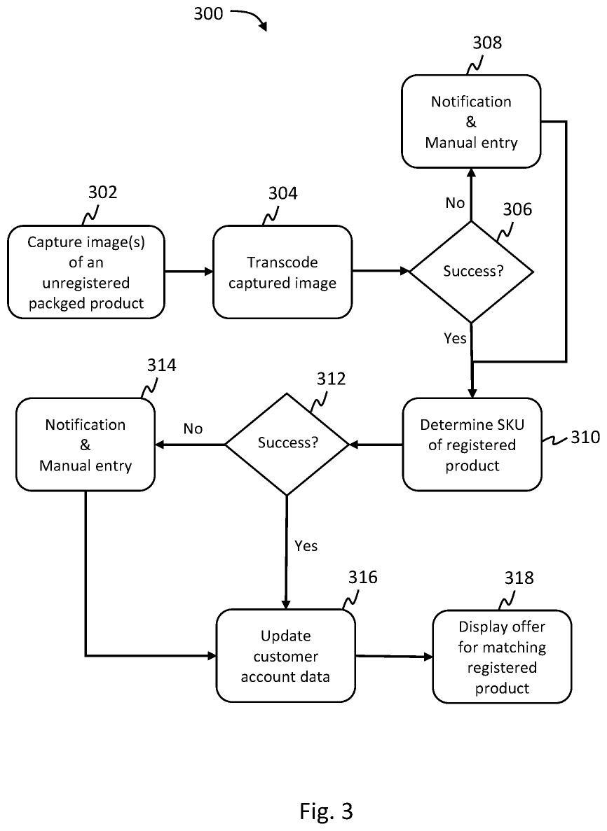

Referring to FIGS. 2A-2F there are shown example user interfaces displayed on a client device 108 illustrating the method depicted in FIG. 3. For sake of brevity, aspects of the present disclosure will be described with reference to an unregistered packaged prescription medication product. However, it should be understood that aspects of the systems and methods discussed herein may apply to other types of unregistered packaged products, including products that have intended and/or expected usage intervals, products that have an expiry date, products that have an expected use lifetime. For example, the unregistered packaged products may include, but are not limited to, over-the-counter medications, foodstuffs, personal hygiene products, cleaning products, batteries, and/or other household items.

Referring to FIG. 2A, there is shown an example customer facing UI 200. Customer facing UI 200 may be displayed on customer device 108 and configured to enable a registered user (e.g., registered customer) to capture an image of an unregistered packaged product 12 that the user wishes to match to a registered product offered for sale at the customer facing UI 200. Prior to what is shown in FIG. 2A, the gateway 104 may transmit for display at the client device 108 the customer facing UI 200 for display at the client device 108.

The gateway 104 may be configured to detect one or more user inputs at the UI 200 corresponding to a registered customer account login credentials. The gateway 104 may query the database 106 to determine whether the received login credentials are correct, and if so, associate interactions with the UI 200 at the customer device 108 with the registered customer account. For example, the registered customer may input their associated login credentials at the UI 200 to associate interactions with the UI 200 with their registered customer account specific data stored on database 106. A registered customer and/or registered user as referenced herein may refer to customers/users that are registered with an entity affiliated with the digital identification service 102 and/or gateway 104. Registered customers may have corresponding registered customer accounts and data stored on database 106.

FIGS. 2A-2F are described in a context where a user of the client device 108 is interacting with the UI 200 while actively logged in to a customer account having customer account specific data stored on the database 106. Gateway 104 and/or digital identification service 102 may be configured to receive and/or detect inputs from the customer facing UI 200 and automatically associate the information corresponding to the inputs with the customer account specific data stored on database 106.

In some embodiments, the gateway 104 is configured to receive and/or detect one or more inputs at the UI 200 indicating a request to match unregistered and registered products. For example, the input received at the gateway 104 may indicate a request received at the client device 108 to identify and match an unregistered packaged product 12 (e.g., a product in the user's possession) to a registered product purchasable at the customer facing UI 200. In response to detecting the request to match an unregistered packaged product 12 to a registered product offered for sale on the gateway 104, the gateway 104 may be configured to cause the UI 200 to render a visual indication of a request for an image of the unregistered packaged product 12. For example, the gateway 104 may be configured to cause the UI 200 to render a visual indication similar to what is shown in FIG. 2A. In some embodiments, the gateway 104 may be configured to transmit a request to the customer device 108 to activate an image capture device in communication with the customer device 108. For example, in an instance where the customer device 108 is a smartphone including a camera, the gateway 104 is configured to transmit a request to activate the camera and display at the UI 200 a digital image generated by the camera. In other embodiments, front-end software and/or hardware of the client device 108 may be invoked to capture one or more digital images of the unregistered product 12 and transmit the one or more digital images to the gateway 104 and/or digital identification service 102.

As illustrated in FIG. 2A, UI 200 is configured to render a visual indication at the client device 108 including an indication of a request to capture, or scan, a digital image of the unregistered product as well as a digital image currently being captured by the activated camera of the customer device 108. FIG. 2A illustrates an example demonstrating aspects of the present disclosure and the appearance of the UI 200 may be different from what is shown in FIG. 2A. In FIG. 2A, the rendered visual indication at the client device 108 includes a visual rendering of an image capture assistance feature in the form of four alignment bars. In some embodiments, the image capture assistance features may include one or more of: a rendering of alignment bars, an interactable lighting activation icon, rendered text or indicia overlay, an interactable help menu icon, an interactable image rotation icon, and panoramic image flattening.

Referring to FIG. 2B there is shown a magnified view of the UI 200 displayed in FIG. 2A. The image of the unregistered packaged product 12 illustrated in FIG. 2B shows a dram that includes a label 14 having identifying indicia printed thereon corresponding to product data for the unregistered packaged product 12. In some embodiments, the identifying indicia included on an unregistered packaged product 12 may include, but is not limited to, one or more of: a quantity, a volume, one or more identifying symbols (e.g., an organization logo), expiration date, product name, product dosage amount and/or strength, an intended subject for use (e.g., a pet name), identifying information of a prescribing entity (e.g., veterinarian name, address, phone number), a chart number, a date the packaged product was prescribed, one or more use conditions (e.g., subject weight restrictions, usage interval restrictions), an intended use (e.g., for heartworm in dogs, flea and tick prevention) and/or a listing of possible symptoms from use thereof. For example, the label 14 in FIG. 2B includes indicia relating to the name (e.g., Medication one) of the unregistered product, a dosage amount (e.g., 100 mg), an expiration date (e.g., October 2023), a quantity of the medication included in the package (e.g., 2 tablets), an intended usage interval (e.g. 1/month), an intended subject of use (e.g., the name of a pet Fluffy) and a name of a prescribing entity (e.g., ABC Vet Clinic). The unregistered packaged product 12 includes identifying indica that may be visible in the digital image. It should be understood though that the unregistered packaged product 12 and the indicia printed on the label 14 are an example for illustrating aspects of the present disclosure and that aspects of unregistered packaged products may include other types of packages, labels, and/or identifying indicia. For example, and without limiting the generality of the preceding sentence, there may be fewer or more identifying indicia than the indicia shown in FIG. 2B.

Referring to FIG. 2C, the gateway 104 may be configured to detect an input at the UI 200 indicating that a digital image 10 of an unregistered packaged product 12, and corresponding image data, has been generated. In response to detecting that the digital image 10 has been generated, the gateway 104 may be configured to transmit the generated digital image 10 and/or corresponding digital image data from the client device 108 to the gateway 104. In some embodiments, in response to receiving the digital image 10, the gateway 104 may be configured to transmit the digital image to the digital identification service 102 for identification. In other embodiments, the gateway 104 may be configured to cause the digital image 10 to be transmitted from the customer device 108 directly to the digital identification service 102. The digital image 10 may include image data corresponding to picture elements (e.g., pixels) each having finite, discrete quantities of numeric representations corresponding to colors (e.g., RGB, grayscale) visible in the digital image 10 (e.g., colors of the packaged product 12, label 14, and indicia printed on the label 14). In some embodiments, the digital image 10 transmitted to the digital identification service 102 may include data relating to the colors of each pixel included in the image 10 (e.g., an RGB value) and a set of edge calculated and/or decoded data related to the digital image 10. In some embodiments, the set of edge calculated and/or decoded data may be null.

Referring to FIG. 2D, in response to receiving the digital image 10, the digital identification service 102 may be configured to identify one or more blocks of data based on the received image 10. The digital identification service 102 may be configured to generate a refined digital image, identify one or more blocks of data based on the refined digital image, and and/or determine a confidence score of the identified one or more blocks of data. In some embodiments, the digital identification service 102 is configured to process the image data of the digital image 10 with an image refinement engine (IRE) to produce a refined digital image. For example, the digital identification service 102 may be configured to process (e.g., edit or alter) the digital image data with the IRE via one or more image filters configured to sharpen the digital image, flatten the digital image, and/or remove depiction of any environmental elements from the digital image (e.g., a depiction of a human hand, finger, fingernail). The digital identification service 102 may be configured to generate a refined digital image that may be decoded by the digital identification service 102.

The digital identification service 102 may be configured to decode the indicia printed on the label 14 of the unregistered packaged product 12 based on the refined digital image. In some embodiments, the digital identification service 102 is configured to decode the refined digital image by processing the refined digital image with an optical character recognition (OCR) utility (e.g., a software application included with the digital identification service 102). In some embodiments, the digital identification service 102 is configured to identify one or more areas on the unregistered packaged product 12 where identifying information is located. For example, the digital identification service 102 may be configured to process the refined digital image with the OCR utility to identify blocks of data on the refined digital image corresponding to text or other identifying indicia on the label 14.

In some embodiments, the identifying information on an unregistered packaged product 12 may be wrapped partially around a curved or rounded surface. For example, in FIG. 2B, the label 14 having the identifying indicia printed thereon, is wrapped at least partially around a curved outer surface of the dram. The digital identification service 102, in some embodiments, is configured to determine a shape of the unregistered packaged product and adjust the processing of the refined digital image thereof with the OCR utility based on the determined shape. For example, the digital identification service 102 is configured to execute a shape detection algorithm on the digital image to determine a geometric shape of the unregistered packaged product depicted therein. In some embodiments, the digital identification service 102 is configured to execute a fisheye video correction algorithm on the refined digital image in order to adjust the OCR based on the shape of the unregistered packaged product 12. In some embodiments, the digital identification service 102 may be configured to use artificial intelligence (AI), such as machine learning (ML), when processing the refined digital image with the OCR utility. The identification service 102 may be configured to process the refined digital image with an OCR utility to decode the refined digital image and identify blocks of data on the refined digital image that may be used when determining a matching or similar registered product. For example, the identification service 102 is configured to identify blocks of data (e.g., product name, dosage, quantity) from the indicia printed on the unregistered packaged product that appears in the refined digital image via the OCR utility. Further to this example, the identification service 102 is configured to compare and/or match the blocks of data from the refined digital image to data for registered products when determining a similarity therebetween.

The digital identification service 102 may be configured to determine a confidence score representative of the accuracy of the identified blocks of data on the refined digital image and in response to the confidence score meeting a predetermined threshold, determine a registered product that is a best fit match to the unregistered packaged product 12. In some embodiments, the digital identification service 102 is configured to apply a confidence scoring engine to the identified blocks of data to determine a confidence score, also referred to herein as a confidence score. The confidence score may be measured in terms of a percentage where 100% represents that the identified data blocks are completely accurate to the identifying indicia included in the image 10 and where 0% represents that the identified data blocks are completely inaccurate to the identifying indicia included in the refined digital image. In some embodiments, if the confidence score is below a minimum amount (e.g., below a 95% confidence score) the digital identification service 102 may be configured to repeat the transcoding process until the confidence score is at or above the minimum confidence score. The digital identification service 102 may be configured to operate in a loop for a predetermined maximum number of times before either terminating or successfully identifying accurate blocks of data based on the refined digital image. A successful identification may refer to the identification of blocks of data corresponding to the unregistered packaged product that has a confidence score equal to or greater than the minimum required confidence score.

In some embodiments, the confidence score may be based, at least partially on one or more similar images. The digital identification service 102 may be configured to map the identified blocks of data to an existing label information hierarchy. In some embodiments, the digital identification service 102 is configured to process the identified data blocks in relation to different data blocks on one or more similar images and determine, at least partially, the confidence score.

In some embodiments, the confidence score may be based, at least partially, on customer account specific data stored in the database 106. As discussed above, the user of the customer device 108 is actively logged in to their registered customer account when the digital image 10 is generated and transmitted to the digital identification service 102. The gateway 104 and/or digital identification service 102 may be configured to automatically associate the digital image 10 with the corresponding registered customer account specific data on the database 106. The digital identification service 102 and/or gateway 104 may be configured to search and/or query the database 106 for registered customer account specific data associated with the registered customer that uploaded the digital image 10.

In some embodiments, the digital identification service 102, in response to identifying blocks of data based on the refined digital image of the unregistered packaged product 12, is configured to compare the blocks of data to one or more data points included in the corresponding registered customer account specific data stored on the database 106. A data point may refer to an identifiable element in a data set. A data set may be, for example, the registered customer account specific data in the database 106 corresponding to a specific customer. Data points may include, but are not limited to, the customer's name, shipping address, purchase history of products purchased via the customer facing UI 200, and data for one or more pets owned by the customer (e.g., pet name, gender, weight, age, breed, prescription medications, health records). The digital identification service 102 may be configured to compare the generated packaged product data to the one or more data points for a registered customer account specific data to determine, at least in part, the confidence score.

For example, the identified blocks of data generated from the refined digital image of unregistered packaged product 12 may include an indication that the unregistered packaged product is a prescription for a pet, or animal, named Fluffy. The digital identification service 102 may be configured to query the database 106 for registered customer account specific data corresponding to a listing of pets included in the registered customer account specific data. Continuing from the above example, if there is an indication in the registered customer account specific data of a pet named Fluffy, the digital identification service 102 may be configured to increase the confidence score by a predetermined amount, and if there is no indication, then the digital identification service 102 may be configured to decrease the confidence score by a predetermined amount. The digital identification service 102 may be configured to repeat this process for a plurality of different data points in order to determine, at least partially, the confidence score.

In some embodiments, the digital identification service 102 is configured to determine the confidence score based on, at least partially, product uses and/or purchases by registered customers having one or more shared characteristics with the registered customer associated with the captured digital image 10. The digital identification service 102 may be configured to determine registered customers having one or more shared characteristics with the registered customer that captured the digital image based on the registered customer account specific data stored on the database 106. A registered customer may log in to their registered customer specific account at the client device 110 prior to capturing and transmitting the digital image 10 to the digital identification service 102. The digital identification service 102 may be configured to receive an indication of the customer account specific data associated with the digital image 10. For example, if a registered customer Bob is logged in to his account at a customer device 108 when transmitting the digital image 10 to the digital identification service 102, the digital identification service 102 may receive a unique identifier (e.g., account number, account name) of Bob's registered customer account specific data with the digital image 10. The digital identification service 102 may be configured to, in response to receiving the digital image 10, identify the registered customer account specific data for the customer that is associated with the digital image 10. In instances where the digital image 10 is determined to be related to a pet or pet related product (e.g., as described herein), the associated customer account specific data identified by the digital identification service 102 may include pet specific data included in the registered customer account specific data.

The digital identification service 102 may be configured to compare the identified registered customer account specific data and/or the pet specific data associated with the digital image 10 to customer account specific data and/or pet specific data stored on database 106 and associated with a plurality of other similar customers and/or pets. The pet specific data associated with a pet may include indications such as, but not limited to, age, weight, breed, gender, and/or one or more past medical conditions. For example, the pet specific data associated with Fluffy may include an indication that Fluffy is a 3-year-old, male golden retriever that weighs seventy-two pounds and was prescribed a heartworm medication one year ago. The digital identification service 102 may be configured to query the database 106 for pet specific data associated with a plurality of other pets that includes one or more similar indications. Continuing from the above example, the digital identification service 102 may be configured to query the database 106 for pet specific data stored thereon that is similar to the pet specific data for Fluffy, such as, in this example, pet specific data that includes indications of pet's that are male, are 3-years old, are golden retrievers, have a weight that is about seventy-two pounds, that were prescribed heartworm medications in the past, or any combination thereof. The digital identification service 102 may be configured to identify pet specific data that is similar to the pet specific data associated with the digital image 10 and/or the refined digital image.

In some embodiments, the customer specific data and/or pet specific data stored in database 106 and associated with registered customer accounts may include an indication of one or more products purchased, such as, but not limited to, indications of medications purchased for use with a specific pet. The identified similar pet specific information may include an indication of one or more past product purchases and corresponding product data. For example, a similar pet specific dataset included in the database 106 may be for a pet Lucy that is a 3-year-old female golden retriever and it may include an indication of a past purchase of a specific heartworm medication that has corresponding product data stored in database 106. Each of the similar pet specific datasets may include for each past product purchase an indication of the product purchased and associated product data stored in database 106. Furthermore, and as discussed above, the digital identification service 102 in response to receiving the digital image 10 may be configured to generate one or more blocks of data, which may, in some instances, match registered product data stored in database 106 for one or more registered products. The digital identification service 102 may be configured to compare the registered product data included in past purchases of registered products indicated in the similar pet specific data to the identified blocks of data and determine whether there are any matches. For example, in an instance where the digital identification service 102 preliminarily determines that the identified blocks of data matches a registered Product A having associated product data stored on database 106, the digital identification service 102 may be configured to query the database 106 to determine how many instances, if any, of past product purchases included in the similar pet specific data include an indication of the registered Product A being purchased.

Further to the above example, if there are no instances of registered Product A being purchased in the past product purchases, the digital identification service 102 may be configured to decrease the confidence score. Where there are instances of registered Product A being purchased, the digital identification service 102 may be configured to increase the confidence score. In this manner, the digital identification service 102 may be configured to determine the accuracy of identified data blocks (e.g., the confidence score) based on, at least partially, whether similar pets and/or customers have purchased the same product.

In some instances, the digital identification service 102 is configured to transmit a request to a client device 110 to identify blocks of data based on the digital image 10 and/or the refined digital image of the unregistered packaged product 12. For example, in response to the digital identification service 102 identifying blocks of data for the unregistered packaged product 12 that result in a confidence score below a predetermined threshold value (e.g., below 95% confidence), the digital identification service 102 may be configured to transmit a request to the client device 110 to identify and input one or more blocks of data. In some embodiments, the digital identification service 102 may attempt to identify the blocks of data a predetermined number of times before transmitting the request to the client device 110. The transmitted request may include the digital image 10, or the refined digital image, and an indication that identification is required for the digital image 10. A user (e.g., customer service representative) may receive the request at the client device 110 and visually inspect the digital image 10 in order to identify the corresponding blocks of data. The client device 110 may be configured to detect user input at a UI displayed on the client device 110 including an indication of the blocks of data corresponding to the unregistered product 12 and determined by the user. In response to receiving the blocks of data at the client device 110, the client device 110 may be configured to automatically transmit the blocks of data to the digital identification service 102. In some embodiments, regardless of whether the digital identification service 102 successfully identifies the blocks of data, one or more blocks of data accurate to the unregistered packaged product 12 may be generated and transmitted to the database 106 and/or digital identification service 102 for use in determining a matching registered product.

In some embodiments, in response to the digital identification service 102 failing to achieve a confidence score above the minimum confidence score, the digital identification service 102 may be configured to cause the customer facing UI 200 to render a request for a different image of the unregistered product 12. For example, the digital identification service 102 may be configured to determine the confidence score of programmatically identified blocks of data resulting in a below minimum acceptable confidence score and transmit an indication to the gateway 104 that the identification was not successful. In response to receiving the indication from the digital identification service 102, the gateway 104 may be configured to cause the UI 200 to render a visual indication at the customer device 108 that identification of the digital image 10 and/or the unregistered product 12 was unsuccessful and that another digital image is requested. For example, the visual indication at the customer facing UI 200 may include text similar to “please take another photo of the product”. The visual indication may be a prompt to take another photo of the unregistered packaged product 12. In some embodiments, the digital identification service 102 is configured to attempt to identify the blocks of data from the refined digital image a predetermined number of times before transmitting a request to the gateway 104 to prompt for a new digital image. In response to receiving the new digital image at the gateway 104, the new digital image may be transmitted to the digital identification service 102 for refinement and identification of data blocks as described above. In an instance where identification of the new digital image is not successful, the digital identification service 104 may be configured to transmit the request for identification to the client device 110 as described above. In some embodiments, the digital identification service 102 is configured to prioritize requesting a new image before transmitting a request for identification to the client device 110. By requesting a new image before transmitting a request for identification to the client device 110 the system 100 of the present disclosure may attempt to reduce the time required to process the digital image 10. For example, the digital identification service 102 is configured to automatically refine and process the digital image 10 which may be substantially faster than transmitting a request to a client device 110 and waiting for a user at the client device 110 to visually inspect the image and manually input identified blocks of data.

Referring to FIG. 2E, in response to successfully identifying the blocks of data corresponding to the unregistered product 12, the system 100 may be configured to determine a matching, or similar, registered product. The digital identification service 102 may be configured to programmatically identify a registered product that is different from and similar to the unregistered product 12. In some embodiments, the digital identification service 102 is configured to generate a final data model associated with the refined digital image that includes a determined confidence score based on at least one of programmatic weighting and decoding metrics, image quality (e.g., clarity of the image), and one or more similarity attributes. The digital identification service 102 may be configured to determine a registered product that is different from and similar to the unregistered product 12 based on the final data model.

In response to identifying blocks of data corresponding to the unregistered packaged product 12 and achieving a confidence score above a predetermined threshold (e.g., above a 95% confidence), the digital identification service 102 may transmit the identified data blocks to the database 106 and/or store the data blocks in a local non-transitory computer readable storage medium. The identified data blocks may include one or more data points each having a data category and corresponding value. For example, and referring to the identifying indicia printed on the label 14 of the unregistered packaged product 12 shown in FIG. 2B, the identified data blocks generated by the digital identification service 102 may include the following categories and values as outlined below in table 1. The identified data blocks may be referred to alternatively as unregistered packaged product data. It should be understood though that the unregistered packaged product data included in table 1 below is an example and that other data categories and/or values may be included in data blocks identified by the digital identification service 102.

TABLE 1
Example of Identified Unregistered
Packaged Product Data/Data Blocks

| Category | Value |
|---|---|
| Product Name | Medication One |
| Dosage | 100 mg |
| Units of Product (Quantity) | 2 |
| Expiration Date | October 2023 |
| Intended Usage Interval | 1/month |
| Prescribed Subject | Fluffy |
| Prescribing Entity | ABC Vet Clinic |

The registered product data stored on database 106 for a plurality of different registered products offered for sale at the customer facing UI 200 may include similar data categories. The digital identification service 102 may be configured to search or query the database 106 based on the data categories and corresponding values included in the unregistered packaged product data. For example, the digital identification service 102 may be configured to query the database 106 for registered product data including a product name category that has a value generally matching Medication One from the unregistered packaged product data. It should be understood though that this example is intended to be non-limiting and that a search or query of the database 106 may be based on multiple data points included in the unregistered packaged product data. In some embodiments, the digital identification service 102 is configured to generate inferred data based on the unregistered packaged product data. For example, and referring to the packaged product data shown in Table 1, the digital identification service 102 is configured to generate inferred data including one or more of: product type, intended use subject, and product ingredients. Further to this example, table 2 below is an example of inferred data generated by the digital identification service 102 based on the unregistered packaged product data shown in Table 1. Another example of inferred data generated by the digital identification service 102 may be a pet weight or size. For example, the unregistered packaged product data may include data relating to a dosage value and an intended dosage per pet weight value and, the inferred data may include the pet weight based on a comparison of the dosage value and intended dosage per pet weight value.

TABLE 2
Example of Inferred Data

| Category | Value |
|---|---|
| Product Type | Prescription Medication |
| Intended Use Subject | Dog |
| Ingredients | Ivermectin/pyrantel |

In some embodiments, digital identification server 102 is configured to use the inferred data to improve the accuracy of determining a matching registered product offered for sale at the customer facing UI 200. For example, in instances where the digital identification service 102 is configured to generate inferred data based on unregistered packaged product data, the digital identification service 102 may narrow a query to the database 106 to include the unregistered packaged product data and inferred data. The digital identification server 102 may be configured to increase accuracy of the search or query as compared to performing a search/query based on the unregistered packaged product data alone. In some embodiments, in response to a matching product being determined by the search or query performed by the digital identification service 102, the registered customer account specific data may be updated in the database 106 to include an association of the product data for the matching registered product. An association of the registered product data for the matching registered product with the registered customer account specific data may include causing the database 106 to update the registered customer account specific data to include one or more data points for the matching registered product. In some embodiments, the digital identification service 102 and/or gateway 104 is configured to cause the database 106 to be updated to include the association.

In some embodiments, the digital identification service 102 may be configured to determine two or more matching registered products and prompt a user for a selection of one of the two or more matching registered products. In some instances, the digital identification service 102 may be configured to determine that there are two or more registered products having product specific data stored on database 106 that best matches the unregistered packaged product 12 within a predetermined confidence score threshold. For example, the digital identification service 102 may be configured to determine that there are three registered products (e.g., Products A-C) that each are associated with a confidence score value above a predetermined threshold of 95%. The digital identification service 102 may be configured to cause the customer facing UI to render a visual indication of each of the matching registered products at the customer device 108 as well as a prompt for a selection of the correct matching registered product. For example, and continuing from the above example, the digital identification service 102 may be configured to cause the customer facing UI to render a visual indication of registered Products A-C as well as text such as, but not limited to, please select one of Products A-C that matches your product. The digital identification service 102 may be configured to detect a selection of one of the matching registered products and cause the customer account specific data stored in database 106 to be updated similar to what is described above. For example, and continuing from the above example, the digital identification service 102 may detect a user selection of registered Product A at the customer facing UI and cause the customer account specific data stored in database 106 to be updated to include an indication that registered Product A is the matching product.

In some embodiments, the digital identification service 102 may be configured to transmit a request to a client device 100 in response to detecting a selection at the customer facing UI indicating that none of the rendered matching registered products are a correct match to the unregistered packaged product 12. For example, and referring back to the above example, in response to rendering a display of registered Products A-C at the customer facing UI, the digital identification service 102 may be configured to detect a selection at the customer facing UI indicating that none of registered Products A-C are a match to the unregistered packaged product 12. The digital identification service 102 may be configured to transmit a request to the client device 110 including the digital image 10 of the unregistered packaged product 12 and/or registered product data for registered Products A-C as well as an indication that unregistered packaged product data is requested. The system 100 of the present disclosure may be configured to enable a user at the client device 110 may receive the request and manually determine a matching registered product similar to what is described above with reference to a confidence score being below a predetermined threshold.

In some instances, the digital identification service 102 may fail to identify a matching registered product and transmit a request to the client device 110 to identify a matching registered product. The failure to identify a matching product at the digital identification service 102 may be the result of, for example, 1) insufficient unregistered packaged product data and/or 2) there being no registered product offered for sale at the customer facing UI 200 that matches the unregistered packaged product 12. In such instances, the digital identification service 102 may be configured to transmit a request to the client device 110 to cause a UI displayed at the client device 110 to render a visual indication that a registered product match is requested. For example, the transmitted request may cause the UI displayed at the client device 110 to render a list of the unregistered packaged product data, the digital image 10, and/or text indicating that a registered product match is requested (e.g., please select a product that is a match to the displayed product information). In some embodiments, the system 100 is configured to enable a user at the client device 110 to request a search of registered products having registered product specific information stored in database 106 to determine if there is a registered product for sale at the UI 200 that matches the unregistered packaged product 12. The user at the client device 110 may be, for example, a customer service representative or other personnel associated with the second party that hosts and/or controls the gateway 104, database 106, and/or the digital identification service 102.

In some embodiments, the digital identification service 102 is configured to receive from the client device 110 a determination of a matching registered product offered for sale at the customer facing UI 200. For example, the client device 110 may be configured to detect a selection of a matching registered product and transmit the matching registered product data to the digital identification service 102. The digital identification service 102 may be configured to, in response to receiving the matching registered product data, cause the customer account specific data in the database 106 to include an association to the matching registered product data. In some embodiments, the client device 110 is in direct communication with the database 106 such that, in response to detecting the selection of a matching registered product, the client device 110 may be configured to automatically cause the customer account specific data in the database 106 to include an association to the matching registered product data.

In some instances, a user at the client device 110 may determine that there is no matching registered product offered for sale at the customer facing UI 200 and submit a request for a matching unregistered product to be purchased from an external vendor. The matching unregistered product may be identified based upon match criteria (e.g., identical matches, product identity, other product similarities). For example, if the user at the client device 110 determines that there are no registered products having corresponding registered product data stored in database 106 that match the unregistered packaged product 12 and/or unregistered packaged product data received from the digital identification service 102, the user may submit a purchase order request for a quantity of a matching unregistered product from an external source (e.g., external vendor, warehouse, wholesale retailer, online retailer). At a time following the submission of the purchase order (e.g., when the corresponding product is received) the client device 110 may cause the database 106 to be updated to include the data for the received unregistered product thereby creating registered product data for the new product. For example, the client device 110 may be configured to detect one or more user inputs corresponding to the new product data and cause the database 106 to store the new product data.

Aspects of FIG. 2E are described herein in the context of the identification server 102 programmatically processing the image data of the digital image 10 as discussed above and identifying a registered product data stored on database 106 corresponding to a registered product that is a match to the unregistered packaged product 12. However, it should be understood that the matching registered product data may be generated according to any of the methods discussed above.

In some embodiments, the system 100 is configured to aggregate records of matching registered products identified by the digital identification service 102 across a plurality of different instances. For example, the system 100 is configured to receive a plurality of different interactions associated with registered users (e.g., customers) uploading images of one or more unregistered packaged products to be identified and matched to a corresponding registered product offered for sale at the customer facing UI 200. There may be a record of all registered products that were matched to images of unregistered packaged products, by the digital identification service 102, stored in database 106. The digital identification service 102 and/or gateway 104 may be configured to update the record stored in the database 106 in response to identifying and matching a digital image of an unregistered packaged product to a registered product. The record of all matched registered products stored on the database 106 may include data points for each different registered product included therein, an indication of the product name and/or a unique product identifier (e.g., product SKU) and a number of times that registered product has been matched to an image of an unregistered packaged product via the digital identification service 102. The digital identification service 102 and/or gateway 104 may be configured to automatically update the record of all matched registered products stored in the database 106. The digital identification service 102 and/or gateway 104 may be configured to query the record of all matched registered products to determine useful product information such as, but not limited to, an expected minimum warehouse inventory amount for a specific product, and/or products that would benefit from pharmaceutical compounding.

Referring to FIG. 2F, in some embodiments, the system 100 of the present disclosure may be configured to automatically determine a replenish time for a registered packaged product identified by the digital identification service 102 and automatically transmit a notification to a customer device 108 including an offer for sale of the matching registered product. The notification may be referred to herein as a replenishment notification. In some embodiments, the digital identification service 102 and/or gateway 104 is configured to cause the customer facing UI 200 to render a visual indication of the replenishment notification at a client device 108. An example of a replenishment notification rendered at the customer facing UI is shown in FIG. 2F. The displayed replenishment notification may include, for example, a rendering of the matching registered product 50, descriptive indicia 52, a displayed price 54 of the matching registered product 50, and one or more interactable elements 56 to enable a registered customer to purchase the matching registered product 50 by interacting with the customer facing UI 200.

The rendering of the matching registered product 50 generated by the gateway 104 may be based on corresponding registered product data for the matching registered product 50 stored on database 106. The descriptive indicia 52 may be digital text displayed on the customer facing UI 200 that indicates to the registered customer that the unregistered packaged product 12 they purchased may have a low remaining quantity and a request for user input. For example, the descriptive indicia 52 may be similar to: Your ‘medication name’ is running low, would you like to purchase more?, where ‘medication name’ is a placeholder for the name of the matching registered product 50 or the name of the unregistered packaged product 12. The displayed price 54 may be an amount of currency required to purchase the matching registered product 50 and may be based on product data for the matching registered product 50 stored in database 106. It should be understood though that the customer facing UI 200 displaying a rendering of the replenishment notification in FIG. 2F is an example and that the customer facing UI 200 may have a different appearance. In some embodiments, the replenishment notification may be sent as an email, text message, or any other form of electronic message.

In some embodiments, the gateway 104 may be configured to determine an appropriate date and/or time to transmit the replenishment notification based on the matching registered product data stored in database 106. The matching registered product data stored in database 106 may include an indication as to a quantity of the unregistered product purchased by the customer at a point in time, an expected or intended usage interval of the unregistered product, and a unique identifier (e.g., SKU) of the registered product corresponding to the registered product data in the database 106. For example, there is shown in table 3 below data points, having a category and corresponding value, included in matching registered product data generated by the digital identification service 102 and stored on database 106. As discussed above, the matching registered product data may be associated with registered customer account specific data for a registered customer (e.g., the registered user of the customer device 108). It should be understood that the data points including the categories and values thereof in table 3 are an example and that other values and/or categories may be included. Some examples of other data points may include, but are not limited to, a date the digital image 10 was captured and/or transmitted to the digital identification service 102.

TABLE 3
Example of Matching Product Data

| Category | Value |
|---|---|
| Product SKU | 1223334445555 |
| Intended usage interval (per month) | 1 |
| Date of last product purchase | Aug. 1, 2022 |
| Quantity of product purchased | 2 |

The indication of a quantity of the unregistered product last purchased by the registered customer at a point in time may be based on the image 10 of the unregistered packaged product 12 transmitted to the digital identification service 102. For example, the digital identification service 102 may be configured to populate the values for the date of last product purchase and quantity of product purchased data point categories based on the determined unregistered packaged product data. The values shown in table 3 are based on the transcoding of the identifying indicia included in the digital image 10 of the unregistered packaged product 12 shown in FIG. 2B and received at the digital identification service 102 on a date. For example, if the digital image 10 is transmitted to the digital identification service 102 on Aug. 1, 2022, the digital identification service 102 is configured to programmatically process the image data included with the digital image 10 (e.g., as shown in FIG. 2D) and in response to determining a matching registered product (e.g., as shown in FIG. 2E) generate the matching registered product data shown in table 3.

The generated matching registered product data may include an indication as to an expected or intended usage interval of the matching registered product. In some embodiments, the expected or intended usage interval is based on the unregistered packaged product data. The expected or intended usage interval, in some aspects, is based on registered product data for the matching registered product stored in database 106. In instances where the expected or intended usage interval of the unregistered packaged product does not match the expected or intended usage interval of the matching registered product, the digital identification service 102 may be configured to prioritize the expected or intended usage interval of the unregistered packaged product data when generating the matching registered product data. By prioritizing the interval of the unregistered packaged product data, the system 100 may more accurately determine the point in time when the unregistered packaged product will no longer contain any units of product.

The gateway 104 may be configured to determine an estimated time when a quantity of an unregistered product (e.g., the unregistered packaged product 12) purchased by a registered customer should be replenished to avoid any period of time where the registered customer is not in possession of said product and/or a point in time where the customer may desire the product but no remaining units of said product are immediately obtainable. In some embodiments, the gateway 104 may be configured to determine based on the matching registered product data stored in database 106, a replenishment date. The determination may be based on the values of the intended usage interval (per month), date of last product purchase, and quantity of product purchased data point categories.

For example, and referring to the values for the matching registered product data categories illustrated in table 3 above, the gateway 104 may determine that a replenishment date is on or before Sep. 1, 2022 or on or before Oct. 1, 2022. The determination of a replenishment date, or date range, by the gateway 104 may be based on a configuration of the gateway 104 to treat the date of product purchase as the first date of product usage. For example, based on the values in table 3, the gateway 104 is configured to calculate the replenishment date based on an assumption that on Aug. 1, 2022 one unit of product of the two total units of product indicated by the quantity value were used resulting in there being one remaining unit of product. Based on the intended usage interval, the gateway 104 may be configured to determine that at the next interval there would be one less remaining unit of product. Continuing from the example above, the gateway 104 is configured to determine that on Sep. 1, 2022 (coinciding with the next one-month interval) one unit of product of the one remaining unit of product would be used/consumed and as such, on Sep. 1, 2022 the customer is no longer in possession of any units of product. In some embodiments, the gateway 104 is configured to determine a date at which the registered customer is expected to no longer be in possession of any units of a specific product. This date may be referenced herein as a zero-inventory date. In instances where the gateway 104 is configured to prioritize preventing the customer from experiencing periods of time in which they are not in possession of the product, the gateway 104 may transmit the replenishment notification to the registered customer prior to the determined zero-inventory date. Continuing from the previous example, the gateway 104 may transmit the replenishment notification prior to Sep. 1, 2022 (e.g., one day prior to, two days prior to, three days prior to, one week prior to).

In some embodiments, the gateway 104 is configured to determine a date coinciding with an upcoming usage interval at which the registered customer is expected to have no remaining units of product. This date will be referred to as a failed interval date. For example, and continuing from the example above, the gateway 104 determined that on Sep. 1, 2022 the units of product expected to be in the possession of the registered customer changes from one to zero coinciding with the use on Sep. 1, 2022. However, based on the expected usage interval (e.g., once per month) the gateway 104 may be configured to determine that the failed interval date is Oct. 1, 2022 (coinciding with the next one-month interval). The gateway 104 may transmit the replenishment notification prior to the failed interval date. In some embodiments, the gateway 104 is configured to transmit a replenishment notification at the zero-inventory date, failed interval date, or a combination thereof. In some embodiments, the replenishment notification may be one of, for example, an email, text message, phone call, or push notification sent to a customer device 108.

The gateway 104 may be configured to determine the date and/or time at which a replenishment notification is sent based on product type. For example, if the matching registered product 50 is a prescription medication for a pet (as illustrated in FIGS. 2A-2F) the gateway 104 may send replenishment notifications at both the zero-inventory date and failed interval date to aid a customer in ensuring that there are no lapses in medication administration to their pet.

In some embodiments, the system 100 is configured to render on a digital user interface, via the digital information service 102, at least one of: i) a selectable offer to purchase the identified registered product 50, and ii) registered product information corresponding to the identified registered product. For example, the digital information service 102 and/or the gateway 104 may be configured to render at the customer facing UI 200 to a registered customer an offer for sale of the matching registered product 50, which may include product information corresponding thereto. In some embodiments, the registered product information comprises reviews of the registered product received from registered users associated with the digital identification service. In some embodiments, the registered product information may include known indications that are treatable with the registered product 50. For example, if the registered product 50 is a canine heartworm medication, the registered product information may include known indications related to heartworms in canines.

In some embodiments, the registered product information includes identification of an additional registered product that is compatible with, or complementary to, the registered product 50. For example, if the registered product 50 is a flea and tick collar, the complementary registered product may be a flea and tick ointment. In some embodiments, the registered product information includes comparison information pertaining to the registered product 50 and the unregistered product 12. For example, the comparison information may include a comparison of how the registered and unregistered product are different (e.g., size, dosage, number of a product in a single package, customer ratings, price). In some embodiments, the registered product information may include a rendering of a selectable option for recurring shipment of the registered product 50. For example, the registered product information may include a rendering of an offer to automatically purchase the matching registered product 50 at a predetermined interval (e.g., once every month). In some embodiments, the registered product information may include recall information, storage information, shelf-life information, one or more viable foreign counterparts (e.g., if the registered product 50 is sold in the Unite States (US) the foreign counterparts may be non-US product alternatives), and/or alternative product information.

In some embodiments, the system 100 is configured to identify a registered user associated with the digital image 10 and the registered product information may include recommendations based on registered user pet information. The gateway 104 may be configured to identify a registered customer/user accessing the gateway 104 (e.g., via a log in in to their registered customer account) prior to, during, or after transmitting the digital image 10 to the digital identification service 102.

Referring to FIG. 3, there is shown a flowchart illustrating a method, generally designated 300, of identifying a registered product and managing an inventory record of the registered product, in accordance with an embodiment of the present disclosure. The method 300 may include the step 302 of capturing one or more images of an unregistered packaged product. For example, and as shown and described above with reference to FIG. 2A, the gateway 104 transmits the customer facing UI 200 to a customer device 108 with a rendering prompting the registered customer to capture an image of an unregistered packaged product 12. In some embodiments, the unregistered packaged product 12 is a prescription medication, that may be packaged in a vial or dram (e.g., as shown in FIG. 2B). In some embodiments, the unregistered packaged product includes identifying indicia printed thereon. For example, and as shown in FIG. 2B, the unregistered packaged product 12 includes identifying indicia printed on the label 14.

The method 300 may include the step 304 of transcoding the captured digital image of the unregistered packaged product. In some embodiments, the step 304 includes receiving the digital image of the unregistered packaged product at a digital identification service. For example, and as shown and described above with reference to FIG. 2C, the digital identification service 102 receives the digital image 10 of the unregistered packaged product 12. The step 304 may include, at the digital identification service, transcoding the image to generate unregistered packaged product data. For example, as shown and described above with reference to FIG. 2D, the digital identification service 102 is configured to process the digital image with an image refinement engine to produce a refined digital image, process the refined digital image with an OCR utility to identify blocks of data on the refined digital image, apply a confidence scoring engine to the identified blocks of data to map information contained within the blocks of data to an existing label. In some embodiments, the method 300 may include at the digital identification service 102, generating a final data model associated with the digital image that includes a determined confidence score based on a programmatic weight and decoding metrics, image quality, and similarity attributes. In some embodiments, the unregistered packaged product data includes an indication of: a number of units of product included in the packaged product, and an expected or intended usage interval of the units of product. For example, as shown in table 1, the unregistered packaged product data includes, one or more data points having categories such as, but not limited to, a number of product units per package and an intended usage interval.

The method 300 may include step 306 of determining whether the transcoding was successful. In some embodiments, the digital identification service 102 is configured to perform step 306. For example, and as described above with reference to FIG. 2D, the digital identification service 102 may determine a confidence score for the unregistered packaged product data. In response to determining that the transcoding failed, the method 300 may include the step 308 of transmitting a notification to an external device and receiving a manual entry of unregistered packaged product data, as discussed above with respect to the client device 110.

In response to successfully transcoding the packaged product data at step 304, or receiving the packaged product data generated at step 308, the method 300 may include the step 310 of determining a stock keeping unit for a matching registered product. In some embodiments, the digital identification service 102 may be configured to perform step 308. For example, and as shown and described above with reference to FIG. 2E, the digital identification service 102 may be configured to identify a registered product offered for sale at the customer facing UI 200 matching the unregistered packaged product based on, at least in part, a comparison of the generated unregistered packaged product data and the registered product data stored in the database 106.

The method 300 may include the step 312 of determining whether the registered product matching at step 310 was successful. In some embodiments, the gateway 104 and/or digital identification service 102 are configured to perform step 310. For example, and as described above with reference to FIG. 2E, the digital identification service 102 may determine whether there is a registered product having registered product data stored in the database 106 matching the unregistered packaged product data. In some embodiments, if the digital identification service 102 and/or gateway 104 fail to identify a matching registered product, the method 300 may proceed to step 314 to request manual entry of a matching registered product. For example, and as discussed above with reference to FIG. 2E, in an instance where a matching registered product is not automatically identified by the digital identification service 102, or gateway 104, a request may be transmitted therefrom to the client device 110 including a request for a manual selection of a matching registered product.

In some embodiments, the method 300 includes the step 316 following either a successful determination of a matching registered product at step 312 or manual entry of a matching registered product at step 314. The step 316 may include updating registered customer account data stored in a database. In some embodiments, the gateway 104 and/or digital identification service 102 may be configured to perform step 316. For sake of brevity though, step 316 will be described with reference to the digital identification service 102. For example, and as discussed above with reference to FIG. 2E, the digital identification service 102 may generate the matching registered product data and cause the registered customer account specific data stored in database 106 to be updated to include an association with the matching registered product data.

In some embodiments, the method 300 may include the step 318 of displaying an offer for a matching registered product. In some embodiments, the gateway 104 is configured to perform the step 318. For example, and as discussed above with reference to FIG. 2F, the gateway 104 may be configured to automatically determine a product replenishment date (e.g., zero-inventory date, failed interval date) based on the number of units of product included in the packaged product 12, and an expected or intended usage interval of the units of the product. The gateway 104 may be configured to at a time at or prior to the product replenishment date, automatically cause the customer facing UI 200 to render a replenishment notification including an offer for sale of the matching registered product.

In this manner, the system 100 and/or method 300 of the present disclosure may enable a user (e.g., a customer) to easily scan an image of an unregistered product (e.g., unregistered packaged product 12) and cause the system 100 to: 1) automatically identify the unregistered product based on the received digital image 10, 2) programmatically process the image data of the digital image to identify a registered product (e.g., product 50) that is different from and similar to the unregistered packaged product, 3) automatically determine when an remaining amount or quantity of the unregistered product is expected to be low, and 4) automatically transmit to the registered user an offer to purchase the identified registered product. The system 100 and/or method 300 of the present disclosure may ease the mental burden on a customer when attempting to remember when and what products they need to purchase. Aspects of the system 100 and/or method 300 of the present disclosure may be particularly beneficial when used to identify and generate automatic replenishment notifications for medications (e.g., pet medications, prescription medications, prescription pet medications, over the counter medications). For example, by implementing the system 100 and/or method 300 for pet medications, there may be a significant improvement in the pet owner's (e.g., customer) ability to ensure that there are units of the medication available each time the medication needs to be administered.

In some instances, the system 100 and/or method 300 of the present disclosure may increase the accuracy and/or amount of product data associated with different registered customers and/or pets. As discussed above, the system 100 may be configured to receive an image 10 of an unregistered packaged product 12, determine a matching registered product (e.g., product 50), and automatically associate the registered product data for product 50 with customer specific data and/or pet specific data stored on database 106. In this manner, the system 100 and/or method 300 may improve the accuracy and/or amount of product data associated with the customer specific data and/or pet specific data stored in database 106 when compared to conventional methods. For example, a conventional method may include transmitting fillable forms to a customer requesting manual data entry of prescription medication information for a specific pet. This conventional method can be very time consuming and is prone to input errors thereby resulting in a user being less likely to spend the time required to fill out and submit the form. The system 100 and/or method 300 of the present disclosure though enables a user to quickly and easily capture an image of a product and automatically associates matching product data with the customer specific data and/or pet specific data stored on database 106. In this manner, the system 100 and/or method 300 may increase the likelihood that a user will provide such product data by eliminating the need for time consuming manual entry on the part of the user and furthermore reduces the risk of receiving incorrect product data. This may be particularly beneficial in instances where a associations between different products and different types of customers and/or pets are used to perform analyses such as, but not limited to: 1) determining current and/or possible future health related concerns of specific medications on a specific category of pet and/or animal (e.g., dogs over the age of five, cats that are between nine to twelve pounds in weight), and 2) determining the effectiveness and/or efficacy of a medication to treat a certain medical condition.

It will be appreciated by those skilled in the art that changes could be made to the exemplary embodiments shown and described above without departing from the broad inventive concepts thereof. It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways.

Specific features of the exemplary embodiments may or may not be part of the claimed invention and various features of the disclosed embodiments may be combined. Unless specifically set forth herein, the terms a, an and the are not limited to one element but instead should be read as meaning at least one. Finally, unless specifically set forth herein, a disclosed or claimed method should not be limited to the performance of their steps in the order written, and one skilled in the art can readily appreciate that the steps may be performed in any practical order.

1. A method of identifying a product from a digital image, the method comprising:
receiving, at a digital identification service, image data associated with a digital image of an unregistered packaged product; and
programmatically processing the image data, via the digital identification service, to identify a registered product that is different from and similar to the unregistered packaged product.

2. The method of claim 1 further comprising:
rendering on a digital user interface, via a gateway coupled to the digital identification service, at least one of: i) a selectable offer to purchase the identified registered product; and ii) registered product information corresponding to the identified registered product.

3. The method of claim 1 further comprising:
identifying a registered user associated with the digital image and wherein the registered product information includes recommendations based on registered user pet information.

4. The method of claim 1, wherein the programmatically processing includes:
processing the digital image with an image refinement engine to produce a refined digital image;
processing the refined digital image with an optical character recognition utility to identify blocks of data on the refined digital image; and
applying a confidence scoring engine to the identified blocks of data to map information contained within the blocks of data to an existing label information hierarchy.

5. The method of claim 1, wherein the programmatically processing includes:
generating a final data model associated with the digital image that includes a determined confidence score based on a programmatic weighting and decoding metrics, image quality and similarity attributes.

6. The method of claim 1 further comprising:
rendering on a user device running client software associated with the digital identification service and configured to capture the digital image, at least one of i) alignment bars, ii) lighting sufficiency indication, iii) a text overlay, iv) a menu, v) rotation functionality, and vi) panoramic image flattening functionality.

7. The method of claim 1, wherein the digital file includes a set of edge calculated and decoded information related to the digital image that is configured to aid in the programmatically processing step.

8. The method of claim 1 further comprising:
establishing an order for recurring shipment of the registered product based on receiving, via the gateway coupled to the digital identification service, a selected offer from a digital user interface.

9. The method of claim 1 further comprising:
at the gateway, programmatically determining a product replenishment date based on the number of units of product included in the unregistered product, and an expected or intended usage interval of the units of the product; and
at a point in time at or prior to the product replenishment date, rendering on a digital user interface a replenishment notification including an offer for sale of the identified registered product.

10. The method of claim 1, wherein the unregistered packaged product is a prescription medication including identifying indicia printed thereon, the identifying indicia including one or more of an indication of product name, quantity, expiration date, dosage, a prescribed subject, and a prescribing entity.

11. The method of claim 1, wherein the unregistered packaged product is packaged in a dram.

12. The method of claim 1, wherein receiving image data associated with a digital image of an unregistered product includes receiving image data associated with a plurality of digital images of the unregistered product.

13. A system for identifying a product from a digital image, the system comprising:
a digital identification service configured to:
receive image data associated with a digital image of an unregistered packaged product; and
programmatically process the image data to identify a registered product that is different from and similar to the unregistered packaged product.

14. The system of claim 13, wherein the digital identification service is further configured to:
render on a digital user interface at least one of: i) a selectable offer to purchase the identified registered product; and ii) registered product information corresponding to the identified registered product.

15. The system of claim 13, wherein the digital identification service is further configured to:
identify a registered user associated with the digital image and wherein the registered product information includes information about the use of the registered product in connection with a pet associated with the registered user.

16. The system of claim 13, wherein the digital identification service is further configured to:
process the digital image with an image refinement engine to produce a refined digital image;
process the refined digital image with an optical character recognition utility to identify blocks of data on the refined digital image; and
apply a confidence scoring engine to the identified blocks of data to map information contained within the blocks of data to an existing label information hierarchy.

17. The system of claim 13, wherein the digital identification service is further configured to:
generate a final data model associated with the digital image that includes a determined confidence score based on a programmatic weighting and decoding metrics, image quality and similarity attributes.

18. The system of claim 13 further comprising:
a gateway in communication with the digital identification service and configured to:
programmatically determine a product replenishment date based on the number of units of product included in the unregistered product, and an expected or intended usage interval of the units of the product; and
at a point in time at or prior to the product replenishment date, render on a digital user interface a replenishment notification including an offer for sale of the identified registered product.
